(19) United States
(12) Patent Application Publication
(10) Pub. No.: US 2003/0046351 A1
(43) Pub. Date: Mar. 6, 2003

(54) Document management system

(75) Inventors: Tomomi Maruyama, Tokyo (JP); Toyoharu Shimada, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/068,944

(22) Filed: Feb. 11, 2002

(30) Foreign Application Priority Data
Sep. 5, 2001 (JP) 2001-268973

(51) Int. Cl. G06F 15/16

(52) U.S. Cl. 709/206

(57) ABSTRACT

A computerized document management system includes a database, mailing means, document registration means, delivery management means and deadline management means. The document registration means makes a preliminary registration of information about a document onto the database and asks a user for an approval of this preliminary registered document using the mailing means. Upon the approval given by the user, the document registration means registers the date of the approval on the database so that the document is formally registered. The formal registration of the document is notified to the departments by the delivery management means using the mailing means. The delivery management means also requests for a confirmation of the notification using the mailing means, and registers reception of the confirmation on the database. In case where the confirmation is not received within a predetermined period of time, the deadline management means reminds the department using the mailing means.

### BACKGROUND OF THE INVENTION

The present invention relates to a document management system.

In an organization such as a corporation and a company, transmission of such information as notice of tasks, knowledge to be shared, rules and regulations is made usually via printed documents, i.e. paper documents. Many of these paper documents including office rules, safety regulations, design manuals must be kept readily accessible at each relevant department. Many of the other documents, such as notice of tasks also have to be kept available at each relevant department at least for a certain period of time in case of need for tracking history.

Therefore, each of the departments in the organization has to classify and keep appropriately the paper documents that they make and those they receive. This requires a space for storage and a huge amount of labor for making ledgers of the documents, filing the documents. Moreover, these documents have to be revised frequently, due to changes made to the rules, reconstruction of the organization, technical advancement. In such a case, according to the conventional paper document delivery, it is difficult to make sure that the old documents have been properly overridden by the newly revised documents, resulting in such a problem that a job is conducted in conformity to the outdated document.

In order to solve these problems, there is an electronic document management system in which the documents are stored centrally in the form of electronic data. According to such a document management system, the documents are stored as electronic data in the document management system, and reading can be made through a terminal connected to the document management system. Therefore, there is no need for each department to individually keep their documents, and it is possible to read the latest document through the terminal at any time.

However, there are still such departments in which their facility or job does not allow reading the electronic documents, or in which the paper document is indispensable in carrying out the job. The conventional document management system which simply converts the documents into electronic data for the storage does not offer any advantage to these departments. Further, there is no method for informing each department of the revisions made to the documents. This poses a problem that it is not possible to make sure whether members of each department are conforming to the revised document in their job.

### SUMMARY OF THE INVENTION

Therefore, an object of the present invention is to provide a document management system capable of managing delivery and receipt of documents reliably, whether or not the documents are electronic or paper.

Another object of the present invention is provide a document management system capable of allowing on-demand reading of not only the latest version but also old versions of the documents which have been outdated due to the revisions.

A further object of the present invention is to provide a document management system capable of instructing relevant members to study the documents, and checking whether these members have studied the documents by a specified day.

To attain the above objects, a document management system according to the present invention is a computerized system in which a database, mailing means, document registration means, delivery management means, tutorial management means and deadline management means are arranged. On the database, information about departments of an organization and information about users in the organization are stored. Moreover, the database stores various information about documents. Upon receiving information about a document from an user, the document registration means makes a preliminary registration of the information about a document onto the database and asks an user for an approval of this preliminary registered document by e-mail using the mailing means. Upon the approval given by the user, the document registration means registers the date of the approval on the database so that the document is formally registered. The formal registration of the document is notified to the departments by the delivery management means using the mailing means. The delivery management means also requests for a confirmation of the notification using the mailing means, and registers reception of the confirmation on the database upon receiving the confirmation. In case where the confirmation is not received within a predetermined period of time, the deadline management means reminds the department by e-mail using the mailing means. For a specific user and specific document, moreover, the tutorial management means instructs the user to read the registered document and requests for a read-through report by using the mailing means. Upon receiving the read-through report, the tutorial management means registers reception of the read-through report on the database. In case where the read-through report is not received within a predetermined period of time, the deadline management means reminds the user by e-mail using the mailing means.

Further, a document management system according to the present invention is a computerized system in which a database, mailing means, document registration means, delivery management means, tutorial management means, deadline management means, search and retrieve means and master management means are arranged. On the database, information about departments of an organization, and information about users in the organization are stored. Moreover, the database stores documents and various information about the documents. Upon receiving a document and information about the document from an user, the document registration means makes a preliminary registration of the document and information about the document onto the database and asks an user for an approval of this preliminary registered document by e-mail using the mailing means. Upon the approval given by the user, the document registration means registers the date of the approval on the database so that the document is formally registered. The formal registration of the document is notified to the departments by the delivery management means using the mailing means. The delivery management means also requests for a confirmation of the notification using the mailing means, and registers reception of the confirmation on the database upon receiving the confirmation. In case where the confirmation is not received within a predetermined period of time, the deadline management means reminds the department by e-mail using the mailing means. For a specific user and specific document, moreover, the tutorial management means instructs the user to read the registered document and requests for a read-through report by using the mailing means. Upon receiving the read-through report, the tutorial management means registers reception of the read-through report on the database. In case where the read-through report is not received within a predetermined period of time, the deadline management means reminds the user by e-mail using the mailing means. To offer the user searching and reading of the registered documents, furthermore, the search and retrieve means is provided. To update the information about the departments of the organization and information about the users in the organization on the database, the master management means is also provided.

Further, a document management system according to the present invention includes a database comprising a department master, a user master, an index table, a file table, an approval table, a delivery table and a tutorial record table. The department master stores a name of all departments, with a department code unique to each of the departments serving as a key. The user master stores a name, an e-mail address and the department code of all the users, with a user ID unique to each of the users serving as a key. The index table stores a document title, the department code of the department which created the document and a scheduled date of document revision, with an indexing number unique to the document serving as a key. The file table stores a place of storage and a file name of the document, with the indexing number serving as a key. The approval table stores the user ID of an approver of the document and a date on which an approval was given by the approver, with the indexing number serving as a key. The delivery table stores the department code of the department to which the document is to be delivered and a date on which a reception confirmation was made by this department, with the indexing number serving as a key. The tutorial record table stores a date on which tutorial is made, with the indexing number and the user ID of the user to receive the tutorial with the document identified by said indexing number serving as keys.

Further, the document management system according to the present invention is characterized in that the document registration means comprises media conversion means. With the media conversion means, a paper document is converted into an electronic document, and that the converted electronic document is registered on the database as the document.

Moreover, the document management system according to the present invention is characterized in that the document registration means comprises electronic approval means for electronically obtaining an approval, and that the approval by the user to the document under the preliminary registration is obtained electronically.

Further, the document management system according to the present invention is characterized in that a request, through the mailing means, for the approval of the document under the preliminary registration and obtainment of the approval through the electronic approval means are performed sequentially to a plurality of users.

In addition, the document management system according to the present invention is characterized in that it is possible to see, through the network, to what extent an approval process of the document has proceeded, based on presence and absence of the approval date on the database.

Furthermore, the document management system according to the present invention is characterized in that a revision code of the document is registered on the database as part of the information about the document. In the case where the registered document is revised, the revision code on the database is altered to a new revision code and the revised new document itself is registered additionally on the database not overridingly. Therefore, it is possible to read both the documents having the new revision code and the document having the old revision code.

In addition, the document management system according to the present invention is characterized in that necessity of a paper document is registered on the database for each of the department. Upon the formal registration of the document, a paper copy of the document is sent to the department which needs the paper document, whereas said department is notified, through the mailing means, of the formal registration.

Further, the document management system according to the present invention is characterized in that necessity of a paper document is registered on the database for each of the department. For such departments to which paper document is delivered, validity of the paper document should be carefully managed. Therefore, the department which needs the paper document is requested, through the mailing means, to return the abolished or outdated version of the document upon abolition or revision of the document.

Moreover, the document management system according to the present invention is characterized in that the deadline management means reminds, by using the mailing means, of the return of the outdated or abolished version of the document if the document was not returned within a predetermined period.

Further, the document management system according to the present invention readably stores the information sent through the mailing means. That is, information about the request to the user for approval of the document under the preliminary registration and the reminder for the approval is stored as a traceable record. Information about the notification to the department about the formal registration of the document and the reminder for the confirmation, the instruction to the user to read the registered document and the reminder for the read-through report, and the request to return the paper document and the reminder for the return of the document may also be stored traceably.

In addition, the document management system according to the present invention is characterized in that a scheduled date for revision of the document and the department that created the document are registered on the database. On the scheduled date or upon approaching of the scheduled date, the deadline management means, by using the mailing means, requests the department that created the document to revise the document.

Further, the document management system according to the present invention is characterized in that it is possible to see presence or absence of the read-through report, for each of the documents, users, departments and periods.

Furthermore, a document management system according to the present invention comprises a department master, a user master, an index table, a file table, an approval table, a delivery table and a return table. The department master stores names of all departments, with a department code unique to each of the departments serving as a key. The user master stores names and the department codes of all users, with a user ID unique to each of the users serving as a key. The index table stores a document title and a current revision code of the document, with an indexing number unique to the document serving as a key. The file table stores a place of storage and a file name of the document, with the indexing number and the revision code serving as keys. The approval table stores the user ID of an approver of the document and a date of approval given by the approver, with the indexing number serving as a key. The delivery table stores a date of reception confirmation made by the department to which the document has been delivered, with the indexing number and the department code of said department serving as keys. The return table stores a date of return from the department to which the document was delivered, with the indexing number, revision code, and the department code of said department serving as keys. With the above, the document management system according to the present invention performs a life cycle management of the document. That is, a document is totally managed through registration of the document upon acquisition of approval when the document is newly created, registration of a revised version of the document upon acquisition of approval and invalidation of the outdated version of the document when the document is revised, and invalidation of the document when the document is abolished.

These and other objects, advantages and features of the present invention will become more apparent from the following description and the accompanying drawings.

### BRIEF DESCRIPTION OF THE DRAWINGS

FIG. 1 is a simplified block diagram showing a document management system according to the present invention and terminals connected thereto via a network;

FIG. 2 shows a user master comprising a part of a database in the present invention;

FIG. 3 shows a department master comprising a part of a database in the present invention;

FIG. 4 shows an index table comprising a part of a database in the present invention;

FIG. 5 shows a file table comprising a part of a database in the present invention;

FIG. 6 shows a approval table comprising a part of a database in the present invention;

FIG. 7 shows a delivery pattern master comprising a part of a database in the present invention;

FIG. 8 shows a destination master comprising a part of a database in the present invention;

FIG. 9 shows a delivery table comprising a part of a database in the present invention;

FIG. 10 shows a return table comprising a part of a database in the present invention;

FIG. 11 shows a tutorial record table comprising a part of a database in the present invention;

FIG. 12 shows a classification master comprising a part of a database in the present invention;

FIG. 13 shows a type master comprising a part of a database in the present invention;

FIG. 14 shows an example of a menu selection screen that is displayed on the user's terminal;

FIG. 15 shows an example of a screen for new registration, which is displayed on the user's terminal;

FIG. 16 shows an example of an approval requesting e-mail;

FIG. 17 shows an example of a tutorial registration screen;

FIG. 18 shows an example of a tutorial notification mail;

FIG. 19 shows an example of a reminder e-mail;

FIG. 20 shows an example of a screen displaying a tutorial status for a user:

FIG. 21 shows an example of a screen displaying a tutorial status for a document and for a department;

FIG. 22 is a block diagram describing the functions provided by the document management system according to the present invention; and

FIGS. 23(a) and 23(b) are tables describing the functions provided by the document management system according to the present invention.

### DETAILED DESCRIPTION

An embodiment of the present invention will now be described with reference to the accompanying drawings.

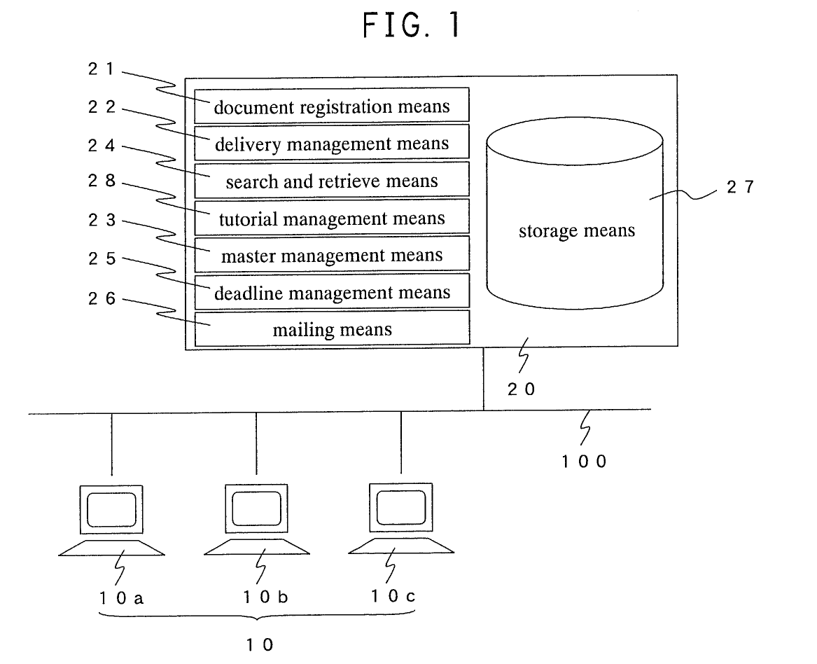

As shown in FIG. 1, a document management system 20 according to the present invention comprises document registration means 21, delivery management means 22, master management means 23, search and retrieve means 24, deadline management means 25, mailing means 26 and storage means 27.

The storage means 27 stores documents obviously, but it also stores a database comprising such information as information of each document, information on users (of the document management system) who make and read the documents, and information on departments to which the users belong.

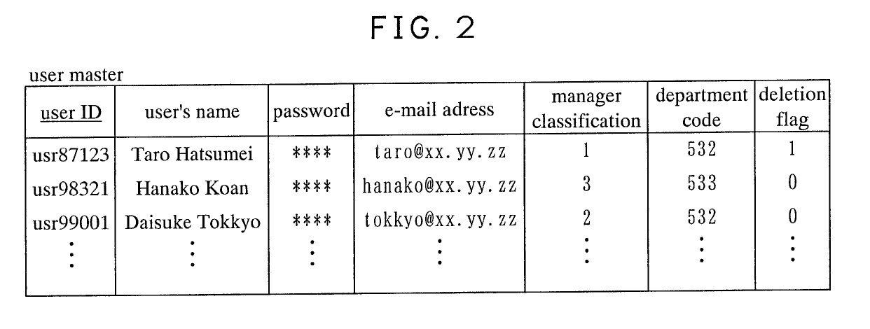

An example of the database construction will be described with reference to FIG. 2 to FIG. 13. According to this example, the database includes a user master, a department master, an index table, a file table, an approval table, a delivery pattern master, a destination master, a delivery table, a return fable, a tutorial record table, a classification master, and a type master.

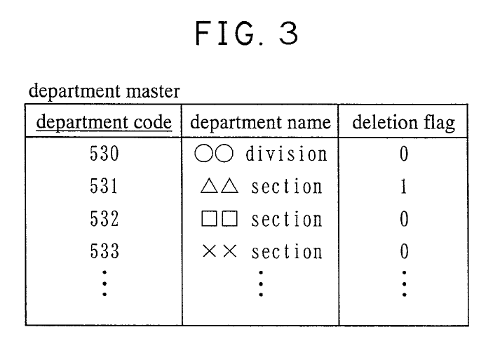

As shown in FIG. 2, the user master stores a name, a password, a mail address, and a department code, of each user, with a user ID unique to each of the user serving as a key. In the accompanying drawings which show tables and masters, those fields used as the keys have their respective names underlined (this applies also to FIGS. 3 to 13).

As shown in FIG. 3, the department master stores a name of each department, with the department code unique to each of the departments serving as the key. Further, preferably, a deletion flag field is provided which indicates whether the department is existent or abolished. With such an arrangement, if the department is not existent due to reorganization and/or renaming, a deletion flag is set (that is, according to the example shown in FIG. 3, a value “1” is placed in the field). The deletion flag enables to know whether the department is existent or abolished. Since the abolished departments are also listed in the department master, it becomes possible to trace history, even if the document is so old. For example, it becomes easy to know which department created the document, to which departments the document was delivered, even if those departments were abolished and not existent. Similarly, it is preferable that the user master described earlier and the destination master to be detailed later should also be provided with the deletion flag field.

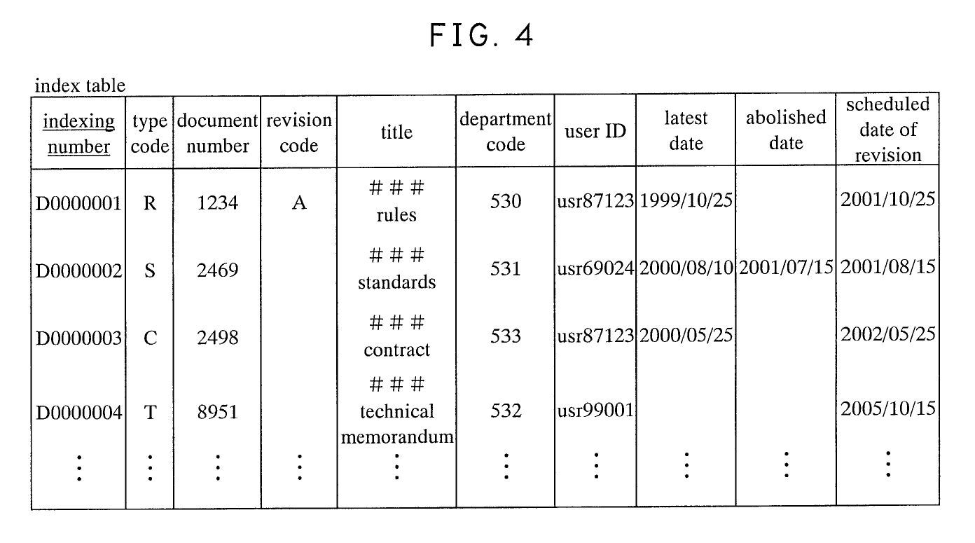

As shown in FIG. 4, the index table stores for each document, a type code which indicates a type of the document, a document number, a revision code, a document title, the department code of the department which created the document, and a date of scheduled revision of the document, with the indexing number unique to each document serving as the key. The indexing number is used primarily for identifying the document in the management system. The document number is primarily used to identify the document by the user. Obviously, there is no absolute need to have two numbering systems (the indexing number and the document number) each capable of identifying the document. However, there is a type of numbering system such as a mechanically generated serial number (i.e. the indexing number) which is more suitable to the document management system, and there is a type of more organized numbering system which is easier for the user to understand and handle (i.e. the document number). By using both numbering systems, a user-friendly document management system can be built easily. Further, the document number facilitates adoption of currently existing documents into the present document management system.

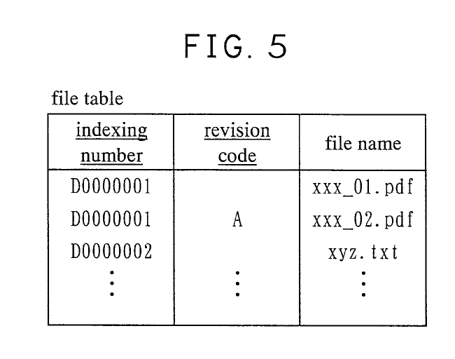

As shown in FIG. 5, the file table stores a file name of each document, with the indexing number and the revision code serving as the keys. Therefore, by using the file table, a place of storage of the document can be found from the indexing number and the revision code.

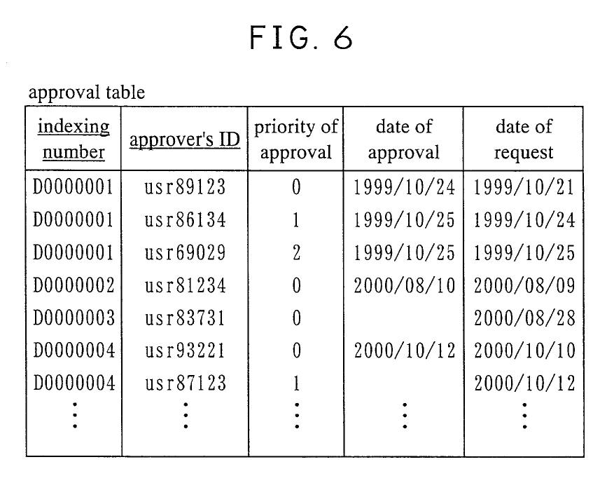

As shown in FIG. 6, the approval table stores the user ID of a person authorized to approve the document (approver), priority of approval, and date of approval, with the indexing number serving as the key.

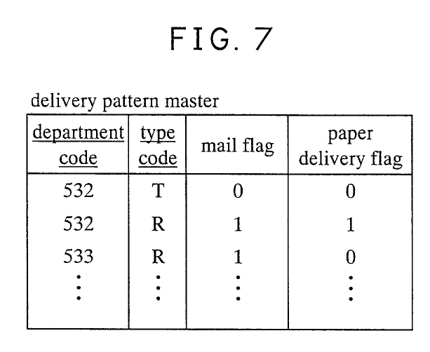

As shown in FIG. 7, the delivery pattern master stores a mail flag which indicates whether it is necessary to make a notification by mail, and a paper delivery flag which indicates whether it is necessary to deliver a paper copy of the document, with the type code which indicates a type of the document and the department code of those to receive the document serving as the keys.

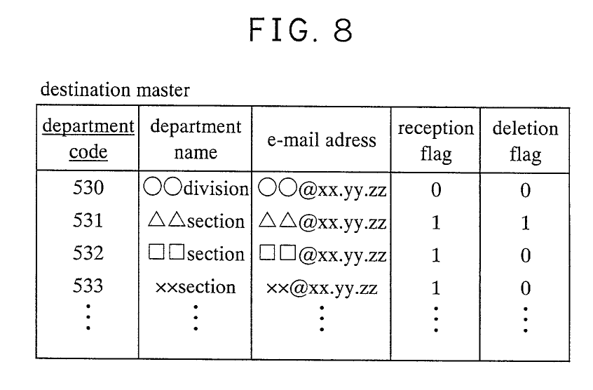

As shown in FIG. 8, the destination master stores the name and a mail address of the department to which the document is delivered, and a reception flag which indicates whether a reception confirmation process of the delivered document is required or not, with the destination represented by the department code serving as the key. In a document management system, it is desirable that all the departments which have received the document should carry out a reception confirmation process, thereby notifying to the document management system that they have received the document. However, for example, there can be some departments to which the document is sent only for reference and therefore there is no need for the reception confirmation process. Thus, according to the example shown in FIG. 8, the destination master is provided with the reception flag field to indicate the need for carrying out the process.

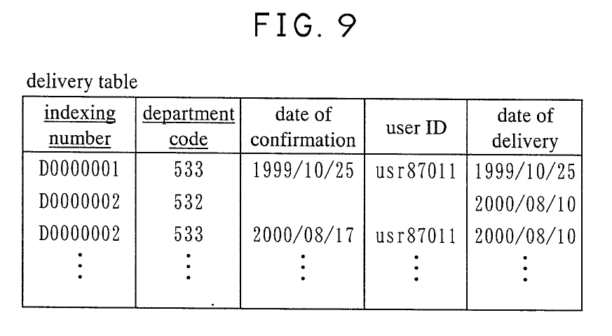

As shown in FIG. 9, the delivery table stores the date of reception confirmation made by the destination department to which the document has been delivered, with the indexing number and the department code of the destination department serving as the keys. Further, the delivery table preferably stores the user ID of the user who made the reception confirmation.

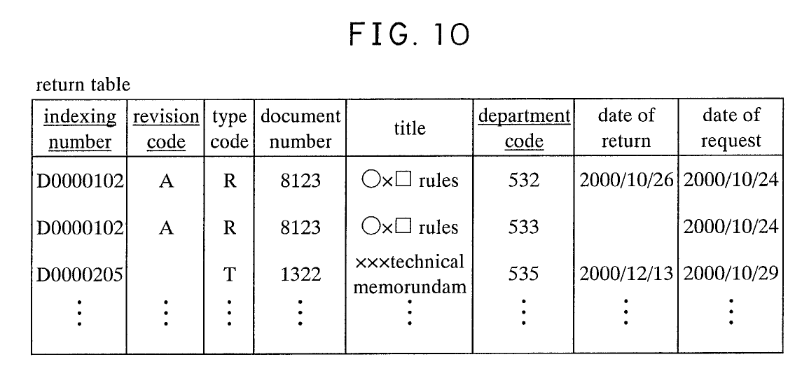

As shown in FIG. 10, the return table stores a date on which a paper copy of the document is returned, with the indexing number and revision code, and the destination department code serving as the keys.

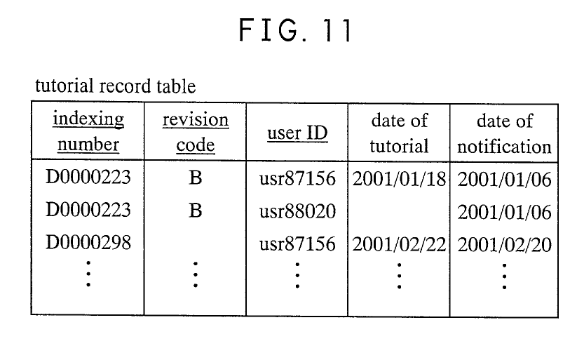

As shown in FIG. 11, the tutorial record table stores the date on which the tutorial is made, with the indexing number and the revision code, and the user ID of the user listed as the tutee serving as the keys.

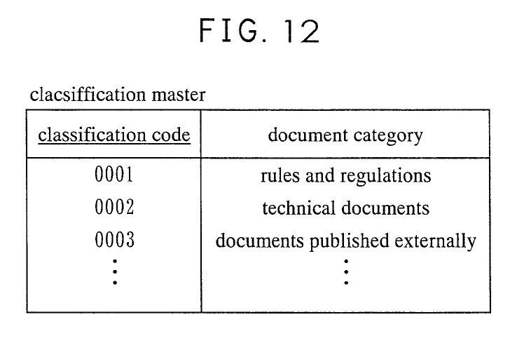

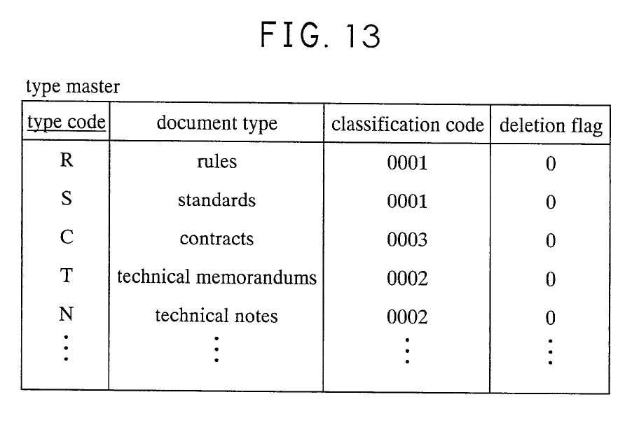

As shown in FIG. 12, the classification master stores names of all classified categories, with a classification code serving as the key. Further, as shown in FIG. 13, the type master stores the names of all types, and the classification code for each of the type, with a type code serving as the key.

Next, an operation of the document management system 20 will be described.

The user uses a terminal 10 (10a, 10b, 10c, . . . ) to connect with the document management system 20 via a network 100. When connecting, it is preferable that the user is requested to input his/her user ID and the password, which are checked against those stored in the user master. This enables to prevent outsiders from pretending the user or otherwise making an access to the document management system.

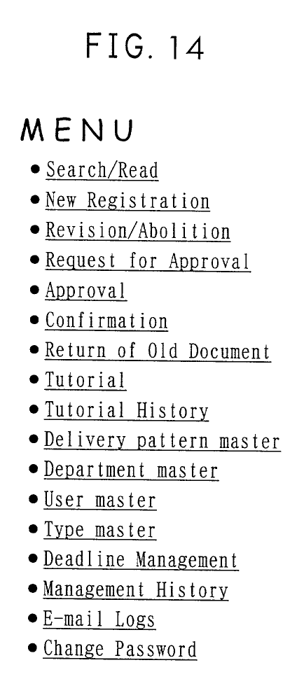

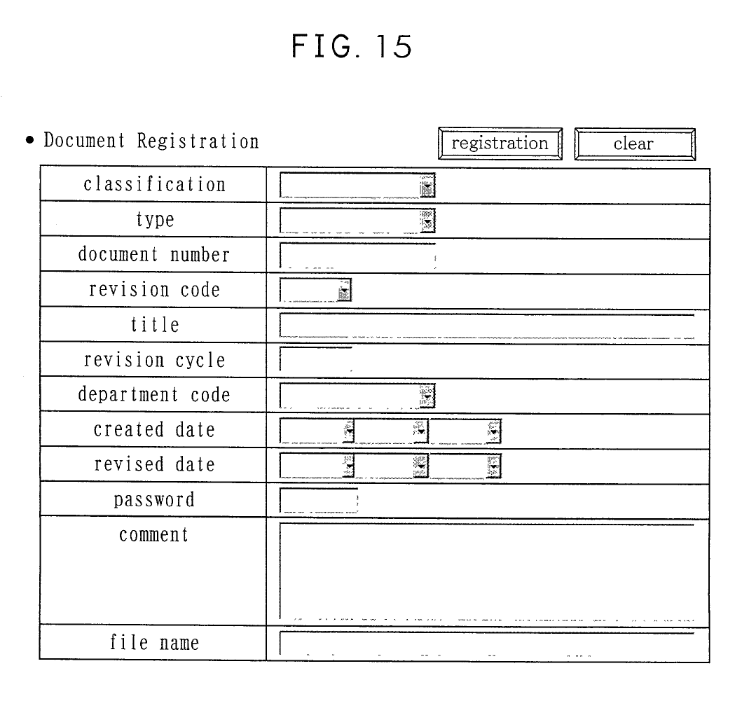

Upon establishment of the connection, the terminal 10 shows a menu selection screen as shown in FIG. 14. If the user selects “New Registration”, the document registration means 21 displays a new registration screen on the user's terminal 10. An example of the new registration screen is shown in FIG. 15. On this new registration screen, the user selects the type, revision code and the department which created the document, inputs the document number, title, and revision cycle, and further, specifies where the document is stored now. The user finally selects “registration”, upon which the information selected and inputted by the user is sent to the document registration means 21.

The document registration means 21 puts a unique indexing number to the information received, and stores the information together with the indexing number, at the index table shown in FIG. 4. At the same time, the ID of this user is stored as a register's ID in a user ID field of the index table. Further, the document file is downloaded from the place of document file storage specified by the user, and stored in the storage means 27. Then, the file name of the document in the storage means 27 is stored in the file table shown in FIG. 5, together with the indexing number.

Such a displaying operation of the menu selection screen and the selection on the menu by the user can be performed through the use of a web browser installed onto the user terminal 10 and an HTML document stored in the document management system 20. Also, the storage operation of the selected and inputted information to the database (such as the index table and the file table) can be performed through the use of ASP (Active Server Pages) technologies.

Now, at this step, information about the document and the document file itself have been stored in the document management system 20, yet the document has not been approved, namely, the document is still on preliminary registration. Therefore, in order to be listed as a formal document, it must be approved.

Thus, the user connects again to the document management system 20, and selects “Request for Approval” from the menu. The document registration means 21 displays on the terminal 10 an approval request screen (not illustrated). The user specifies the document by the document number, tide or the indexing number, and then specifies a user who is supposed to approve. The specification is sent to the document registration means 21, and the indexing number of the document and the user ID of the appointed approving user are stored in the approval table in FIG. 6. The approval table includes an approval priority field, which allows the user to specify a plurality of approving users with priority orders.

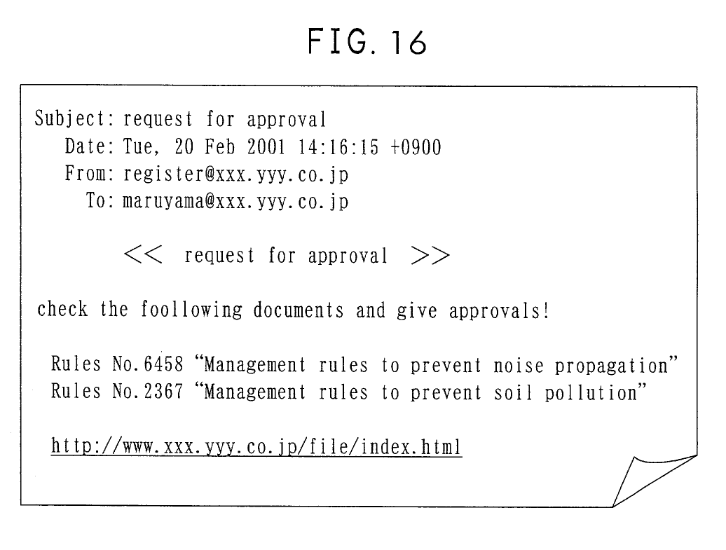

Upon storage on the approval table, the system first picks the approving user of the highest priority (for example, the approver whose priority field has the value “0” on the approval table in FIG. 6), and sends his/her user ID together with the document indexing number to the mailing means 26. The mailing means 26 makes reference to the user master to identify the mail address of this approver, and sends an e-mail that requests the approval. An example of the approval requesting e-mail is shown in FIG. 16. Preferably, such information as the document number, document title, name of the document creator (who requests the approval) can be picked from the index table and user master so that the e-mail may include these information.

The user who receives the approval requesting e-mail uses the terminal 10 (10a, 10b, 10c, . . . ) and via the network 100, to connect to the document management system 20. The terminal 10 displays a menu selection screen in FIG. 14. The user selects “Approval” from the menu. Then, the document registration means 21 shows an approval screen (not illustrated) on the terminal 10. On the approval screen, the user specifies the document by the document number, title or the indexing number, confirms what is written in the document, and then approves the document. Obviously, an arrangement may be such that the approval requesting e-mail includes an URL of the approval screen, so that the user can use clickable URL function of an e-mail client to make direct connection to the approval screen for the document in question.

The approval is made electronically via the network 100. Preferably, an encryption system such as a public key encryption system and a secret key encryption system should be used to verify the identification of the user and to check if the approval is valid.

Completion of the approval process thus made by the approving user is informed to the document registration means 21, and on the approval table, the date of approval is stored into the approved date field of a record specified by the indexing number of this document and the user ID of the approving user.

Storage of the approval date in the approved date field confirms the approval by the first approving user. Successively, then, the system picks the approving user of the second priority (for example, the approver whose priority field has the value “1” on the approval table in FIG. 6), and sends his/her user ID together with the document indexing number to the mailing means 26.

As has been described, the mailing means 26 makes reference to the user master to identify the mail address of this approver, and sends an e-mail to request for the approval. The user who receives the approval requesting e-mail uses the terminal 10 (10a, 10b, 10c, . . . ) and via the network 100, to connect to the document management system 20 and gives an approval. Giving the approval is informed to the document registration means 21, and the date of approval is stored into the approved date field of a record specified by the indexing number of this document and the user ID of this approving user.

In this way, approvals are sequentially given according to the given order of approval priority described in the approval table. Once all of the approvals have been obtained, that is, all of the approved date fields have been filled with the respective dates of approval, the document is treated as an formally registered document, and become available for search and reading via the search and retrieve means to be described later.

Alternatively, approvals may be given not sequentially but simultaneously. That is, e-mails to request for approvals are sent to two or more users having same approval priority at the same time, and the document is formally registered upon obtainment of the all approvals from these users. Further, a user may be designated as a deputy for another user. In this case, the document could be treated as a formally registered document upon obtainment of the approval from either of the users. In these ways, the system of more flexible approving procedure is also possible.

Once approved and registered, the documents are then delivered to relevant departments. Herein, the term “deliver” includes not only that a paper copy of the document is actually delivered, but also delivering of an e-mail which notifies registration of a new document. The delivery is made according to the delivery pattern master. As shown in FIG. 7, the delivery pattern master uses as its keys the type code which indicates the type of documents, and the department code of the department to which the delivery is to be made, and stores the mail flag which indicates whether it is necessary to make notification by mail, and a paper delivery flag which indicates whether it is necessary to deliver a paper copy of the document.

For the type code of the newly registered document, the delivery management means 22 selects those departments whose mail notification flag has a value “1”, that is to say, the departments which “needs notification by mail”, and sends their department codes to the mailing means 26. The mailing means 26 makes reference to the destination master in FIG. 8 to identify the mail addresses of these departments, and sends an e-mail to each of these departments to notify them of the registration of new document. Further, to each of those department whose paper delivery flag has a value “1”, that is to say, the departments which “needs paper delivery”, a paper copy of the document is sent. Preferably, the delivery management means 22 provides assistance in the paper delivery operation by e.g. displaying the names of departments to which the paper should be delivered, notifying said names of departments to the manager of the document management system by e-mail, printing the document and cover letters.

Upon the delivery of the document (including the case where the deliver was only made through a notification by mail), the indexing number of the document and the department code of the destination are stored in the delivery table in FIG. 9. As has been described earlier, the delivery table stores the date of reception confirmation, with the indexing number and the department code of the destination department as the keys.

The user who receives the notification through e-mail or paper copy of the document at each department uses the terminal 10 (10a, 10b, 10c, . . . ) to connect to the document management system 20 via the network 100. The terminal 10 displays a menu selection screen in FIG. 14. The user selects “Confirmation” from the menu and then the delivery management means 22 shows a screen for confirmation (not illustrated) on the terminal 10. The user specifies the document by the document number, title or the indexing number, and proceed with the reception confirmation procedure.

The completion of the reception confirmation procedure is notified to the delivery management means 22, whereupon the date of the reception confirmation procedure is stored in the date of confirmation field of the delivery table. Preferably, the delivery table has a field for storing the user ID who confirmed the reception, and the user ID who performed the reception confirmation procedure may be stored therein.

As has been described, according to the present invention, it is possible to obtain approval of a new document, deliver the document after the approval is obtained, and confirm reception of the document, on the web (site). Further, by referring to the approved date field of the approval table and the date of confirmation field of the delivery table, it is possible to track current approval status of the document or reception confirmation status of the document after the delivery. Further, preferably, the approval table and the delivery table may each have a date field for storing the date on which the request for approval was made or the delivery was made. With these date fields, and by using the deadline management means 25 and the mailing means 26, it is possible to remind the user or the department that did not approve the document or confirm the reception within the predetermined period.

The deadline management means 25 also performs management of the document revision deadline. Since the index table stores the scheduled revision date for each of the document, on the day of the scheduled revision, or as the day of the scheduled revision approaches, the deadline management means 25 uses the mailing means 26 and sends an e-mail requesting the department for a review of the document. This can ensure periodic review of the document.

Aside from the periodic review, the document may need revision from time to time, due to revision of rules and regulations, restructuring in the organization, technical advancement or needs for correcting errors. In such a case, from the menu screen shown in FIG. 14, “Revision/Abolition” is selected, which presents a revision/abolition screen (not illustrated) on the terminal 10. On the revision/abolition screen, the user specifies the revision code and the place of storage of the revised document. The document as after the revision is transmitted to the storage means 27, and its file name is stored newly in the file table together with the new revision code. As for the indexing number, the indexing number used for the document before the revision is used successively. Thus, in the index table, the record of this indexing number has its revision code field filled with the new revision code.

As has been described, since the latest revision code is stored in the index table for each of the documents, and the file table stores the document file names of old and new revision codes, with the document indexing number and the revision code as the keys. Therefore, at any time, the latest version of the document is offered for the reading, and in addition, documents of old revision codes can also be read as necessary.

If the document itself becomes unnecessary and thus to be abolished, then from the menu screen, “Revision/Abolition” is selected, which presents the revision/abolition screen (not illustrated) for specifying the abolition of the document. In the index table, the record of this document has its abolished date field filled with a date, and thereafter the document is treated as abolished. In this way, the currency of the document is managed on the abolished date field, and the corresponding record is not deleted from the index table and the file table. Therefore, the old documents can also be read depending on needs.

If the revised document has its previous version, whose revision code therefore has been outdated, being distributed in the form of paper, it is necessary to assure that all of the paper copies are collected. The delivery management means 22 makes reference to the destination master and the delivery table to identify those to which the paper copy of the document was delivered, and then requests all of these to return the paper. At the same time, the indexing number of the document and the department ID of the destinations are registered on the return table in FIG. 10. The return table comprises a date of return field, with the indexing number and the department code of the destination department serving as keys.

Upon returning of the old paper of the outdated revision code, the user who received the old document uses the terminal 10 (10a, 10b, 10c, . . . ) via the network 100, to connect to the document management system 20. The terminal 10 displays a menu selection screen in FIG. 14. The user selects “Return of Old Document” from the menu. Then, the delivery management means shows a return procedure screen (not illustrated) on the terminal 10, the user specifies the document by the documents number, title or the indexing number, and inputs the date when the document was returned. The date is stored in the date of return field of the return table, indicating that this particular document has been returned.

Preferably, as in the approval table and the delivery table, the return table may also have a date field for storing the date on which the request for the return was made. This makes possible to remind the user or the department that did not return the document within the predetermined period.

For some of the documents thus registered and delivered, it will be necessary to make sure that the document is read by the user and that this reading history is recorded. According to the present invention, the tutorial record table shown in FIG. 11 and tutorial management means 28 shown in FIG. 1 are used to instruct the user to read the document and to record the reading history. The tutorial record table uses the document indexing number and the user ID as the keys, and has the tutorial date field for storing the date on which the document was read for studying by the user.

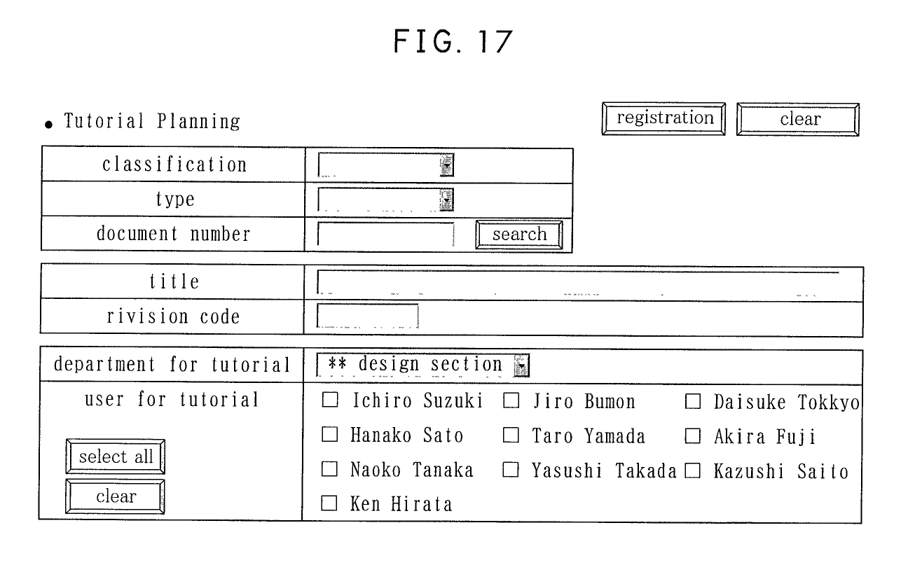

The user who has authorization on the tutorial uses the terminal 10 (10a, 10b, 10c, . . . ) and via the network 100, to connect to the document management system 20. The terminal 10 displays a menu selection screen. The user selects “Tutorial” from the menu. Then, the tutorial management means 28 shows a tutorial registration screen on the terminal 10. An example of the tutorial registration screen is shown in FIG. 17. The user selects the classification, type and document number, thereby searching and specifying the document which needs to be read, namely the tutorial document. Further, the user specifies the department as a receiving department of the tutorial. Then, the display shows user names belonging to the selected department, so that specific users can be selected as tutee users by checking a check box.

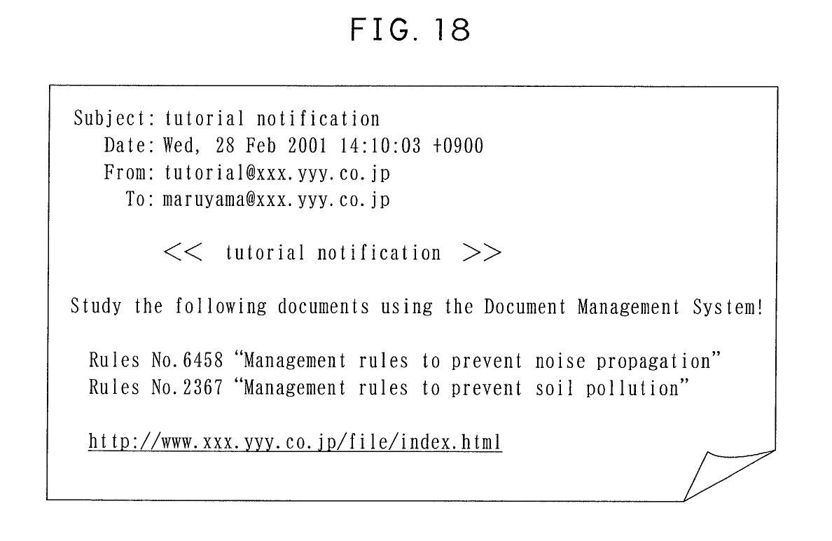

Upon the selection, the tutorial management means 28 sends to the mailing means 26 the user ID's of the tutee users and the indexing number of the tutorial document. The mailing means 26 send to each of these users an e-mail as shown in FIG. 18, thereby notifying about the tutorial document. At the same time, the indexing number of the tutorial document and the user ID's of the tutee users are registered on the tutorial table in FIG. 11.

The tutee user who receives the tutorial notification e-mail uses the terminal 10 (10a, 10b, 10c, . . . ) and via the network 100, to connect to the document management system 20. The terminal 10 displays a menu selection screen in FIG. 14. The tutee user selects “Tutorial History” from the menu. Then, the tutorial management means 28 shows a list of the documents, which should be read and studied by the tutee user, on the terminal 10. Obviously, an arrangement may be such that the tutorial notification e-mail includes an URL of the above list of tutorial documents, so that the tutee user can use clickable URL function of an e-mail client to make direct connection to the list of tutorial documents.

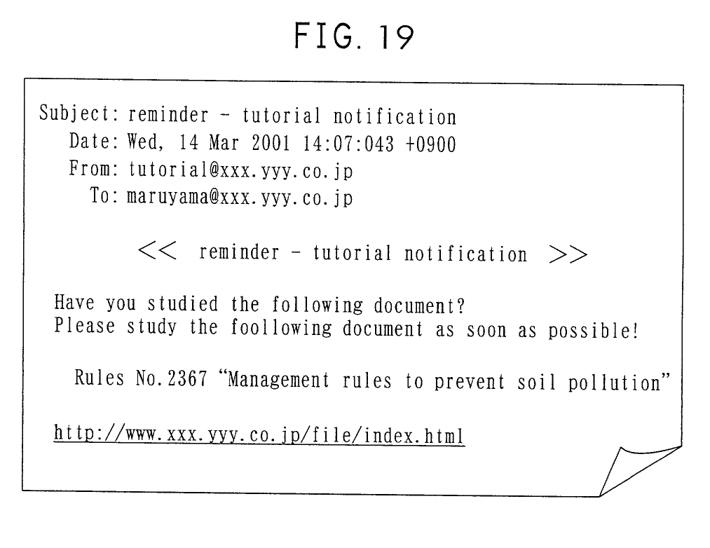

The tutee user clicks to select, from a list of tutorial document, a link to the specified document to display the document on the terminal 10, and read this document. After the reading, the user gets back to the list of tutorial document, and clicks a “studied” button. The date of his reading is stored in the tutorial date field of the tutorial table, which indicates that the tutorial with this document has been finished. Preferably, the tutorial table should also be provided with the date field so that the date of sending the tutorial notification is stored. With this, it becomes possible to have the deadline management means 25 and the mailing means 26 to send an e-mail about tutorial notification shown in FIG. 19 to remind the user of prompt reading if the tutorial, i.e. the reading of the document, has not been made within a predetermined period.

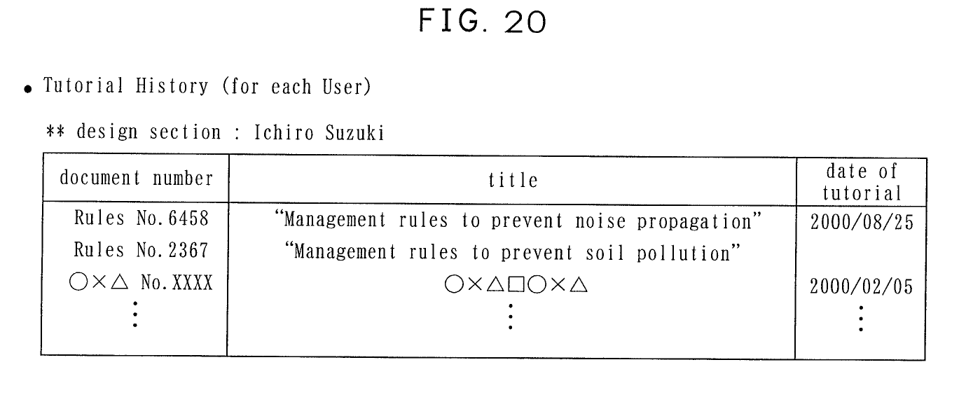

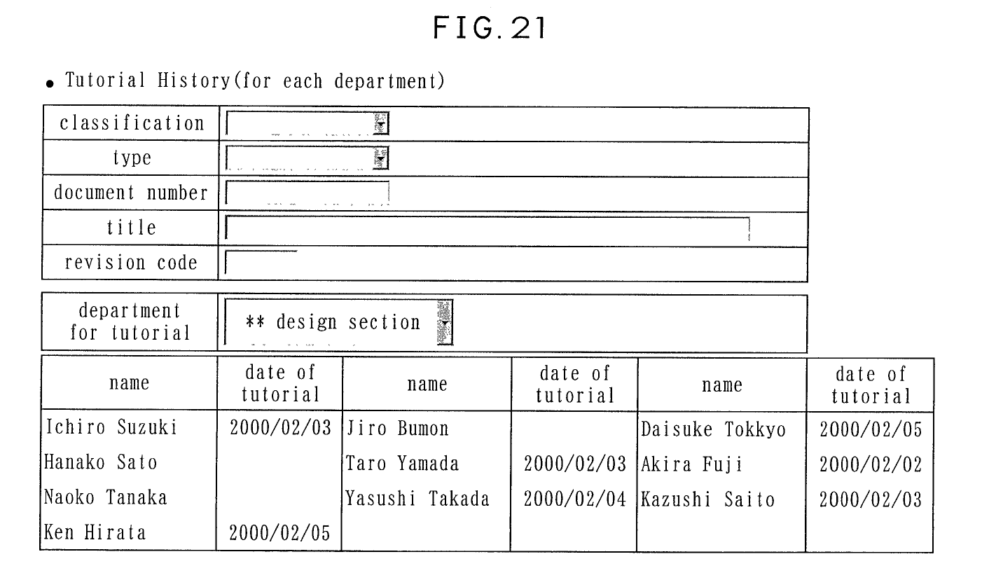

As has been described, the tutorial table stores the indexing number of the document and the user ID. In addition, the tutorial date is 20 stored if the tutorial has been finished. Therefore, as shown in FIG. 20, by displaying a list of tutorial documents and their respective date of tutorial for each of the users, it is possible to check if the tutorial has been finished, for all the tutorial documents. Further, by displaying a list of tutee users and their respective tutorial date for each of the documents, it is possible to 25 check the tutorial with a particular one of the documents has been finished, for each user. Further, the user master stores the department code of the department to which each user belongs. Thus, it is also possible as shown in FIG. 21, to specify a tutorial document and the tutorial receiving department, and to check tutorial status of the users in a particular department. Further, it is of course possible to specify a specific period of time, and display a list of tutorial carried out in the selected period.

As described above, according to the present invention, for each document and for each user, status of reading, that is the state of tutorial can be grasped, and completion of the reading can be recorded as a history. This guarantees that each user at each department is carrying out their job in conformity to the latest document, and the record can serve as an evidence submitted for an ISO approval, for example.

Further, the document management system according to the present embodiment includes the classification master (FIG. 12) which stores information on the category to which the document is classified, with the classification code serving as the key, and the type master (FIG. 13) which stores the document type and the classification code, with the type code serving as the key. Namely, the classification master serves as a major classification system, whereas the type master serves as a minor classification system. These classification systems enable hierarchical management of the document, facilitating reading and searching. Obviously, the hierarchy may not be limited to two levels, but may have an intermediate level, or even greater number of levels, by using another master for handling even a finer classification for example.

According to the document management system offered by the present embodiment, various kinds of search are possible by using the index table, approval table, delivery table or tutorial record table. The user uses the terminal 10 (10a, 10b, 10c, . . . ) and via the network 100, to connect to the document management system 20. The terminal 10 displays a menu selection screen. The user selects “Search/Read” from the menu. Then, the search and retrieve means 24 shows a screen for searching documents (not illustrated) on the terminal 10.

The user can make a search by specifying one or more information stored in the tables such as the type code, document title, department code of the department which created the document, approval date, abolition date. Further, the index table may include comment field to allow inputting of a comment when the document is put under the preliminary registration, so that the comment may also be utilized for the search. Further, the classification master and/or the type master may also be used so that the search can be performed on a specific category or type. Furthermore, the file table may be used so that the text data included in the storage means 27 can be utilized for the search.

Further, preferably, the document registration means 21 according to the present embodiment should be provided with media conversion means for conversion of a paper document into an electronic document. The media conversion means may be provided by an optical reading device such as a scanner, as well as a character recognition system including an OCR. The media conversion means converts the paper document into an electronic file in such a format as jpeg, BMP, pdf and text. Such a conversion enables registration and approval of the document without handling a paper document.

Organizational restructuring, personnel transfers, as well as changes made to the document controlling system may give rise to a need to change the masters, e.g. the department master, user master, destination master or type master. In such a case, the user selects from the menu selection screen in FIG. 14 the master to be changed. The master management means 23 shows an edit screen (not illustrated) for the specified master, so that the user can update the master through the master editing screen.

Additionally, in order to prevent an unauthorized user from altering the master, preferably, the user master is provided with a manager classification field to indicate authorization given to each user. Further, the arrangement may be such that the authorization is graded into a number of levels. For example, the user who has level “1” management authority can only search and read the documents, the user who has level “2” management authority can make registration, revision, and abolition, in addition to the search and read, and further, the user who has level “3” management authority can also perform reception confirmation and return procedures.

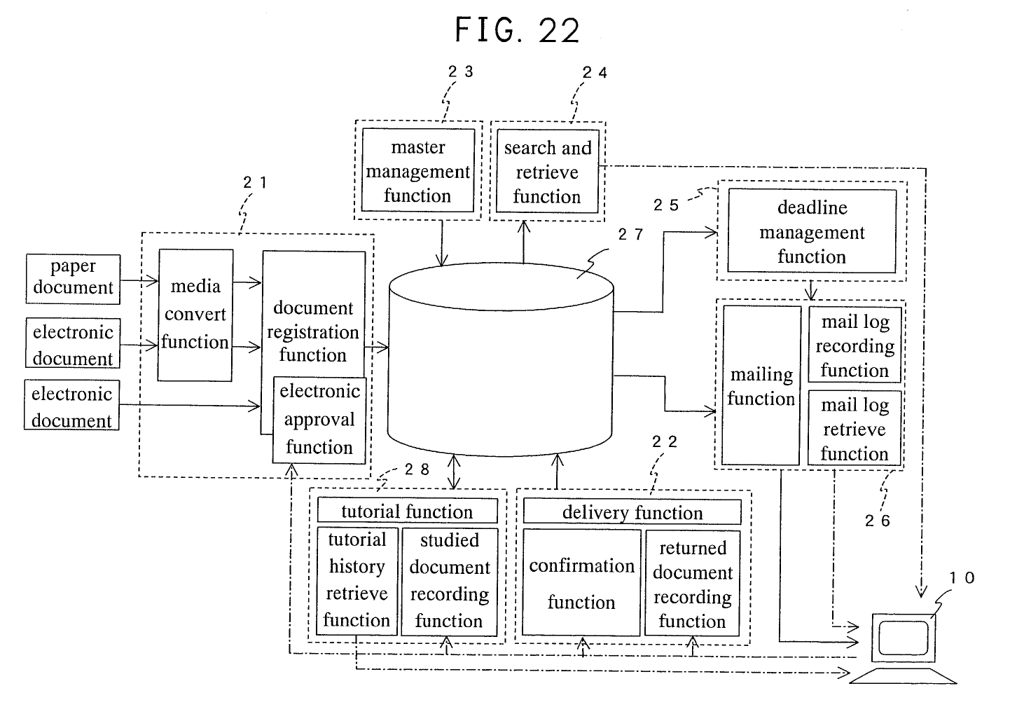

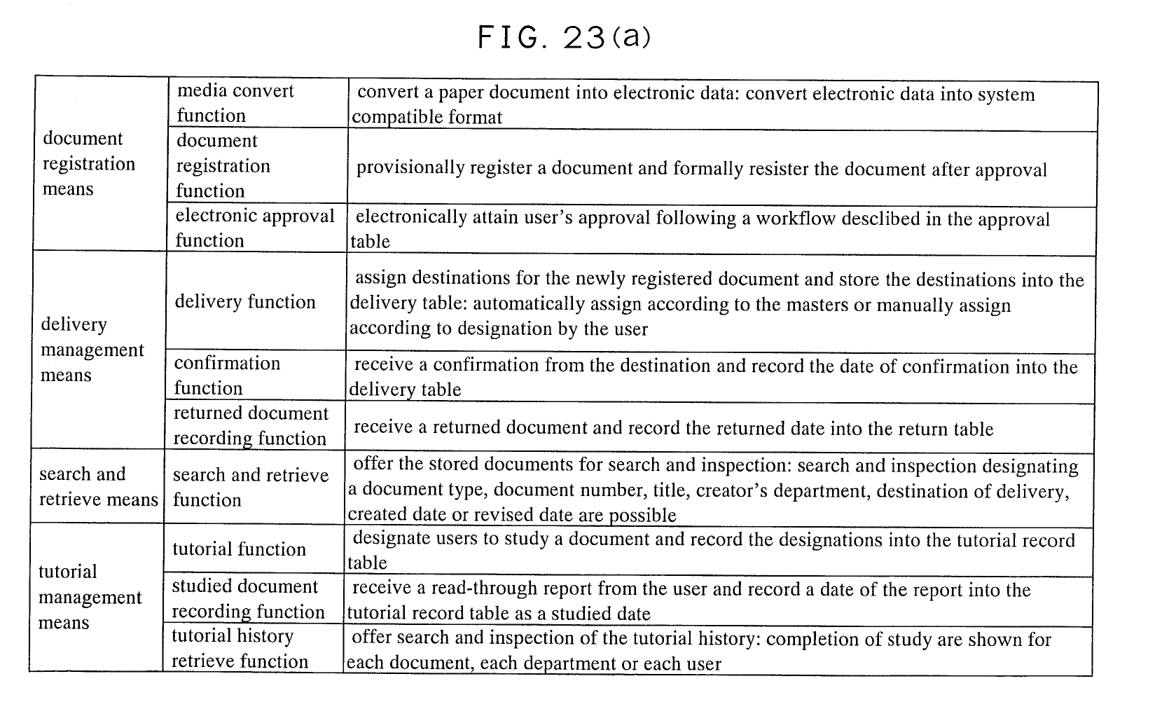

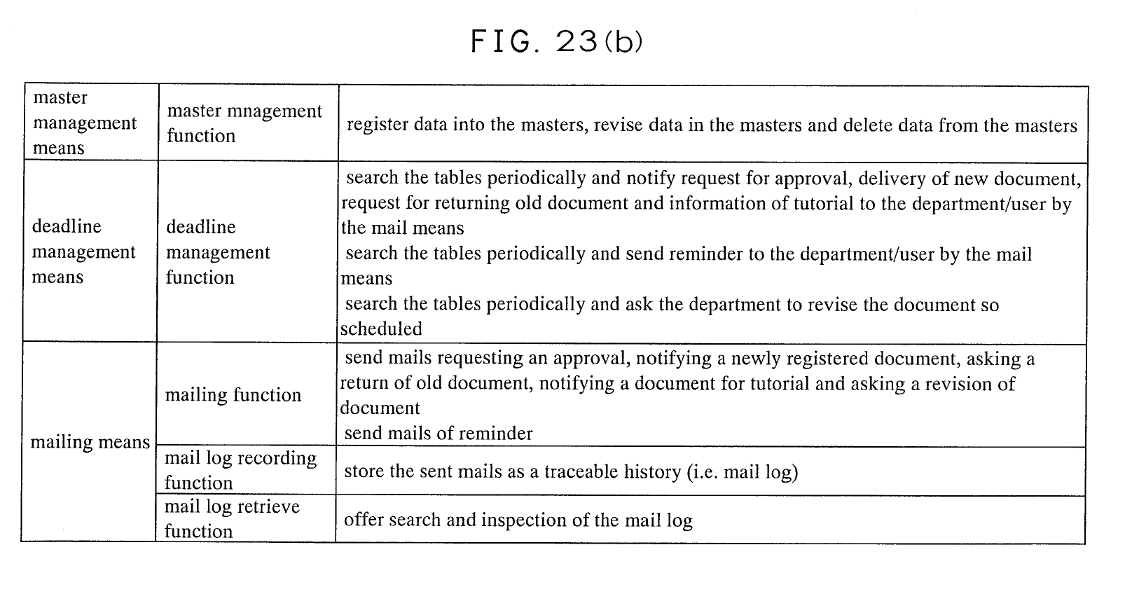

These functions provided by the document management system according to the present invention are depicted in a block diagram in FIG. 22. Further, each of the functions is summarized in FIGS. 23(a) and 23(b).

As shown in FIG. 22, the document registration means 21 provides a document registration function and an electronic approval obtaining function, and desirably the media conversion function. The document registration function makes preliminary registration of various information on the document into the database on the storage means 27. The electronic approval obtaining function obtains an approval for the preliminarily registered document. As has been described earlier, the approval procedure is carried out in accordance with a predetermined workflow, namely in the order of approval priority stored in the database, through the request for approval by e-mail, and through inspection and electrical approval issuance both using a web browser.

As shown in FIG. 22, the delivery management means 22 provides a delivery function, a reception confirmation function and a returned document record function. The delivery function notifies each department of a new registration of document by e-mail. Each notified department confirms the reception of document and makes reception procedure on the terminal 10. The reception confirmation function stores the date of confirmation in the database for each department and for each document. Likewise, if there is an older document which needs to be returned, the delivery function requests each relevant department of the return, by e-mail. The returned document record function stores the date of return in the database for each department and for each document. In this way, it is possible to confirm that the new document has surely been delivered to each department, and old document have been surely returned.

As shown in FIG. 22, the tutorial management means 28 provides a tutorial function, a studied document record function and a tutorial history retrieve function. Using the tutorial function, tutee users are selected for each document, and a notification is made to each tutee user by e-mail. The tutee user reads and studies the document, and makes a read-through report from the terminal 10. The studied document record function stores the date of read-through report submitted by the tutee user in the database. The date information can be read through the tutorial history retrieving function. Therefore, it is possible to see whether the tutorial, i.e. reading of the document, has been performed or not, in the form of a list classified by the user, document or department.

The deadline management means 25 provides a deadline management function, and reminds by e-mail those users and departments that have not fulfilled the approval, reception confirmation, return of the document, or the submission of the read-through report, within a predetermined period. Further, for the document whose revision deadline is approaching, a request for the revision is made by e-mail to the department that created the document. Furthermore, it is possible to use the deadline management function as a filter for searching or retrieving, thereby excluding expired documents from being picked by a search or from being read.

The mailing means 26 provides a mailing function, mail log record function and a mail log retrieve function. The mailing function sends e-mails to the terminals 10 of relevant users and departments. These mails concern the request for approval, notification of newly registered document, request for returning a document, and tutorial instruction asking the user to read a document, and are requested by the electronic approval function, delivery function and tutorial function. Further, those e-mails such as the reminder and the document revising request issued from the deadline management function are also sent to the terminals 10 of relevant users and departments. The mails are simultaneously stored by the mail log record function so that they can be read through the mail log retrieve function.

The search and retrieve means 24 provides a search and retrieve function, enabling the searching for and reading of the document through the terminal 10.

The master management means 23 provides a master management function, enabling update and correction to each of the masters stored in the database. The master management function allows to flexibly respond to organizational restructuring, personnel transfer, change made to the document control procedures. Further, by limiting access to the master management function according to the level of authority given to the user, it is possible to prevent an unauthorized user from altering the master.

The document management system according to the present invention has been described thus far. The database of the document management system according to the present invention is not limited to the one configured as described. For example, a variation in which the department master may have a mail address field instead of the mail address field of the department master is possible, and those skilled in the art will easily understand that there can be many other variations within the technical scope of the present invention.

The document management system according to the present invention enables reliable delivery and reception of the document through notification and reception confirmation by e-mail, whether the document is electronic or paper.

Further, the latest version of the document can be assuredly offered for the reading, with an advantage that the outdated document before the revision or abolished document can also be read as necessary.

Further, a history of document from approval, through registration and revision, to abolition can be controlled. This enables to prevent troubles caused by lack of thoroughness in document management.

Further, since the reading history for each user, document and department is stored, it is guaranteed that each of the users in each of the departments is carrying out their relevant job in conformity to the proper document.

What is claimed is:

1. A document management system comprising:
a database which stores information about departments of an organization, information about users in the organization, and information about documents;
mailing means for sending an e-mail to any of the departments or any of the users in the organization;
document registration means which makes a preliminary registration of information about a document on the database, asks the user by using the mailing means for an approval of the document under the preliminary registration, and registers a date of the approval given by the user on the database, thereby formally registers the document;
delivery management means which notifies the formal registration of the document to the department and requests for a reception confirmation of the notification by using the mailing means, and registers reception or non-reception of the reception confirmation on the database;
tutorial management means which instructs the user to read the registered document and requests for a read-through report by using the mailing means, and registers reception or non-reception of the read-through report on the database; and
deadline management means which reminds the department or the user by using the mailing means if the reception confirmation or the read-through report is not received within a predetermined period of time.

2. A document management system comprising:
a database which stores information about departments of an organization, information about users in the organization, documents and information about the documents;
mailing means for sending an e-mail to any of the departments or any of the users in the organization;
document registration means which makes a preliminary registration of a document and information about the document, asks the user by using the mailing means for an approval of the document under the preliminary registration, and registers a date of the approval given by the user on the database, thereby formally registers the document;
delivery management means which notifies the formal registration of the document to the department and requests for a reception confirmation of the notification by using the mailing means, and registers reception or non-reception of the reception confirmation on the database;
tutorial management means which instructs the user to read the registered document and requests for a read-through report by using the mailing means, and registers reception or non-reception of the read-through report on the database;
deadline management means which reminds the department or the user by using the mailing means if the reception confirmation or the read-through report is not received within a predetermined period of time;
search and retrieve means for searching for and reading of a document on the registration via a network; and
master management means for updating the information about the departments of the organization and about the users in the organization.

3. A document management system comprising a database wherein the database comprises:
a department master which stores a name of departments, with a department code unique to each of the departments serving as a key;
a user master which stores a name, an e-mail address and the department code, of users, with a user ID unique to each of the users serving as a key;
an index table which stores a document title, the department code of the department which created the document, and a scheduled date of document revision, with an indexing number unique to the document serving as a key;
a file table which stores a place of storage and a file name of the document, with the indexing number serving as a key;
an approval table which stores the user ID of an approver of the document and a date on which an approval was given by the approver, with the indexing number serving as a key;
a delivery table which stores the department code of the department to which the document is to be delivered and a date on which a reception confirmation was made by the department, with the indexing number serving as a key;
a tutorial record table which stores a date on which tutorial is made, with the indexing number and the user ID of the user to receive the tutorial with the document identified by said indexing number serving as keys.

4. The document management system of claim 2 wherein the document registration means comprises media conversion means for converting a paper document into an electronic data so that the converted electronic data is registered on the database as the document.

5. The document management system of claim 1 wherein the document registration means comprises electronic approval means for electronically obtaining an approval so that the approval by the user to the preliminary registered document is obtained electronically.

6. The document management system of claim 5 wherein a request for the approval on the preliminary registered document through the mailing means and an obtainment of the approval through the electronic approval means are performed sequentially to a plurality of users.

7. The document management system of claim 1 wherein a progress in obtaining the approvals is determined based on presence or absence of the each approval date on the database and shown to users via a network.

8. The document management system of claim 1 wherein a revision code of the document is registered in the database as part of the information about the document, and revision of the document is completed by an alteration of the registered revision code to a new revision code and addition of the revised document to the database, so that both the document having the new revision code and the document having the old revision code are retrievable.

9. The document management system of claim 1 wherein the information registered on the database comprises whether or not a paper document must be delivered for each of the departments, and for the department which needs paper document, a notification of formal registration of the document is sent through the mailing means and a paper copy of the document is delivered as well.

10. The document management system of claim 1 wherein the information registered on the database comprises whether or not paper document must be delivered for each of the departments, and upon abolition or revision of the document, the department which needs the paper document is requested, through the mailing means, to return the abolished or outdated version of the document.

11. The document management system of claim 10 wherein the deadline management means reminds, by using the mailing means, of the return of the outdated or abolished version of the document if the document was not returned within a predetermined period.

12. The document management system of claim 1 in which the information sent through the mailing means about request to the user for approval of the document under the preliminary registration and the reminder for the approval, the notification to the department about the formal registration of the document and the reminder for the reception confirmation, the instruction to the user to read the registered document and the reminder for the read-through report, and the request to return the paper document and the reminder for the return of the document are stored and retrievable.

13. The document management system of claim 1 wherein the information registered on the database comprises the department which created the document and a scheduled date for revision of the document, and the deadline management means, by using the mailing means on the day of the revision, requests the department which created the document to revise the document.

14. The document management system of claim 1 wherein presence or absence of the read-through report is retrievable for each of the documents, users, departments and periods.

15. A document management system comprising:
a department master which stores names of departments, with a department code unique to each of the departments serving as a key;
a user master which stores names and the department codes of the users, with a user ID unique to each of the users serving as a key;
an index table which stores a document title and a current revision code of the document, with an indexing number unique to the document serving as a key;
a file table which stores a place of storage and a file name of the document, with the indexing number and the revision code serving as keys;
an approval table which stores the user ID of an approver of the document and a date of approval given by the approver, with the indexing number serving as a key;
a delivery table which stores a date of reception confirmation made by the department to which the document has been delivered, with the indexing number and the department code of said department serving as keys;
a return table which stores a date of return from the department to which the document was delivered, with the indexing number, revision code, and the department code of said department serving as keys; wherein
a life cycle management of the document from approval and registration of a new document, through revision, approval and registration of a revised version of the document handled with the revision code, to return of the document when the document is abolished or when its revision code has been outdated is performed.
